(19) United States
(12) Patent Application Publication
(10) Pub. No.: US 2009/0107658 A1
(43) Pub. Date: Apr. 30, 2009

(54) Metallic material for brazing, brazing method, and heat exchanger

(75) Inventors: Shin Takewaka, Kariya-city (JP); Sumio Susa, Anjo-city (JP); Tooru Ikeda, Nukata-gun (JP); Shoei Teshima, Handa-city (JP); Anders Falkeno, Vasteras (SE); Ulrik Palmqvist, Vasteras (SE); Leif Tapper, Vasteras (SE)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Luvata Sweden AB, Vasteras (SE)

(21) Appl. No.: 12/290,300

(22) Filed: Oct. 29, 2008

(30) Foreign Application Priority Data
Oct. 30, 2007 (JP) 2007-282382

(51) Int. Cl. F28F 19/00; B32B 15/20; B32B 15/01; B23K 31/02

(52) U.S. Cl. 165/133; 428/576; 228/176

(57) ABSTRACT

A brazing method is provided for brazing a metallic material for brazing to another metallic material. The metallic material for brazing includes a base material portion made of copper or a copper alloy containing chrome by a predetermined amount, and a metallic film portion made of a material having a melting point lower than a heating temperature in brazing, and provided on the surface of the base material portion. The brazing method includes a step of assembling the metallic material for brazing and the another metallic material to form an assembly, a step of heating and brazing the assembly, in which the metallic film portion is melted to diffuse chrome into a surface of the metallic material for brazing, and a step of forming a chrome oxide film by using the chrome diffused into the surface of the metallic material for brazing in atmosphere after the brazing step.

### CROSS REFERENCE TO RELATED APPLICATION

This application is based on Japanese Patent Application No. 2007-282382 filed on Oct. 30, 2007, the contents of which are incorporated herein by reference in its entirety.

### FIELD OF THE INVENTION

The present invention relates to a metallic material for brazing, a brazing method, and a heat exchanger.

### BACKGROUND OF THE INVENTION

Conventionally, in order to improve corrosion resistance of a metallic material, a plating is applied to the outer surface of a copper or copper-alloy water feeding device, and then a different kind of plating is applied only to the inside of the water feeding device by a chemical plating method or a displacement plating method, as disclosed in, for example, JP-A-2001-348692.

A chrome plating having excellent corrosion resistance is used as the uppermost plating layer applied to the outer surface of the water feeding device. Furthermore, in order to form a stiff oxide film on the surface of the plating, a heat treatment is performed at a high temperature (900° C.) in the last step of plating.

The technique as disclosed in JP-A-2001-348692, however, is to improve corrosion resistance of the surface of the water feeding device, and fails to disclose the contents of brazing of the water feeding device to another metallic member. That is, when another metallic member is brazed to the surface of the metallic material subjected to plating, an oxide film is formed on the surface of the plating by heat in brazing, thereby it is difficult to braze two members well. Conversely, after the two members are brazed to each other and then subjected to plating, it may be difficult to plate the two members having a complicated shape after the brazing.

### SUMMARY OF THE INVENTION

In view of the forgoing problems, it is an object of the present invention to provide a metallic material for brazing, a brazing method or/and a heat exchanger, which have excellent corrosion resistance and brazing properties.

According to an aspect of the present invention, a metallic material for brazing includes a base material portion made of copper or a copper alloy containing chrome in a predetermined amount, and a metallic film portion that is made of a material having a melting point lower than a heating temperature in brazing and is provided on a surface of the base material portion.

When the metallic material for brazing is used to be brazed to another metallic material in an oxidation reduction atmosphere, the metallic film portion becomes a molten state. The metallic material is brazed to the another metallic material, while the chrome in the base material portion is diffused into a surface of the metallic material by the molten metallic film portion. After the brazing, the chrome diffused into the surface of the metallic material forms the chrome oxide film in the atmosphere.

Accordingly, the brazing can be accurately and effectively performed without being inhibited by the chrome oxide film during the brazing. The chrome oxide film after the brazing can improve the corrosion resistance of the metallic material for brazing. As a result, the metallic material for brazing can be provided as a material having excellent brazing properties and corrosion resistance.

The metallic film portion may be made of any one of tin, a tin alloy, zinc, and a zinc alloy. Thus, it is possible to easily set the metallic film portion having a low melting point.

The metallic film portion may be provided by any one of electroplating, electroless plating, displacement plating, hot-dip plating, cladding, and thermal spraying. In this case, it is possible to easily form the metallic film portion.

The predetermined amount of the chrome contained may be 0.1% by weight or more. In this case, it is possible to easily form a thick chrome oxide film after the brazing, thereby ensuring sufficient corrosion resistance.

A thickness of the metallic film portion may be 2 μm or more. In this case, the molten state of the metallic film portion can be surely formed in brazing, thereby inducing the more diffusion of the chrome into the surface thereof. Thus, a relatively thick chrome oxide film can be formed after the brazing.

According to another aspect of the present invention, a brazing method for brazing the metallic material for brazing to another metallic material includes an assembling step for assembling the metallic material for brazing and the another metallic material in a predetermined positional relationship to form an assembly; a brazing step for heating and brazing the assembly in the oxidation reduction atmosphere, in which the metallic film portion is melted to diffuse the chrome into the surface of the metallic material for brazing during the brazing step; and a film formation step for forming a chrome oxide film by using the chrome diffused into the surface of the metallic material for brazing in an atmosphere after the brazing step.

In the brazing step, the chrome is in a diffused state to be diffused into the surface, and does not form the chrome oxide film. Therefore, the brazing property can be performed without being inhibited by the chrome oxide film. The chrome oxide film formed in the film formation step after the brazing step can improve the corrosion resistance of the metallic material for brazing. Accordingly, the brazing properties and corrosion resistance can be effectively improved.

The metallic material for brazing and the another metallic material may be materials for forming a first member and a second member, respectively, for constituting a heat exchanger. Accordingly, it can provide the brazing method for the heat exchanger having excellent brazing properties. Furthermore, the completed heat exchanger having excellent corrosion resistance can be provided.

According to another aspect of the present invention, a heat exchanger includes a first member formed of the metallic material for brazing, and a second member formed of another metallic material. Furthermore, the first member and the second member are brazed to each other, and a chrome oxide film is formed on a surface of the first member by using the chrome diffused into the surface of the first member in the brazing. Accordingly, it is possible to provide the heat exchanger with the excellent corrosion resistance.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a cross sectional view showing an initial state of a metallic material for brazing, according to a first embodiment of the present invention;

FIG. 2 is a cross sectional view showing an intermediate state of brazing the metallic material for brazing to another metallic material;

FIG. 3 is a cross sectional view showing a state after brazing of the metallic material for brazing to the another metallic material; and

FIG. 4 is a graph showing the results of experiments of corrosion resistance after the brazing, in accordance with initial chrome amounts of the metallic materials for brazing and plating thicknesses, according to the first embodiment.

### DETAILED DESCRIPTION OF THE PREFERRED EMBODIMENTS

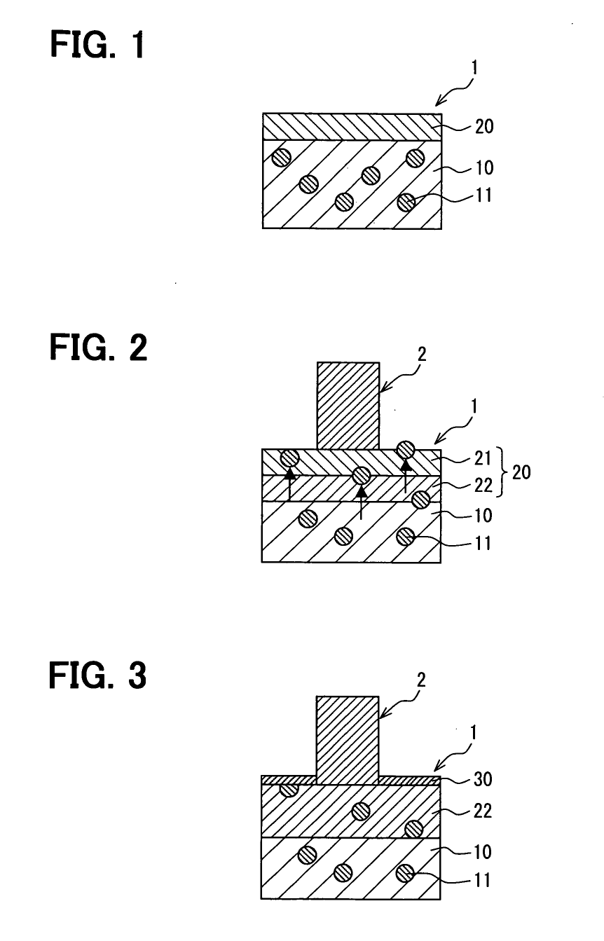

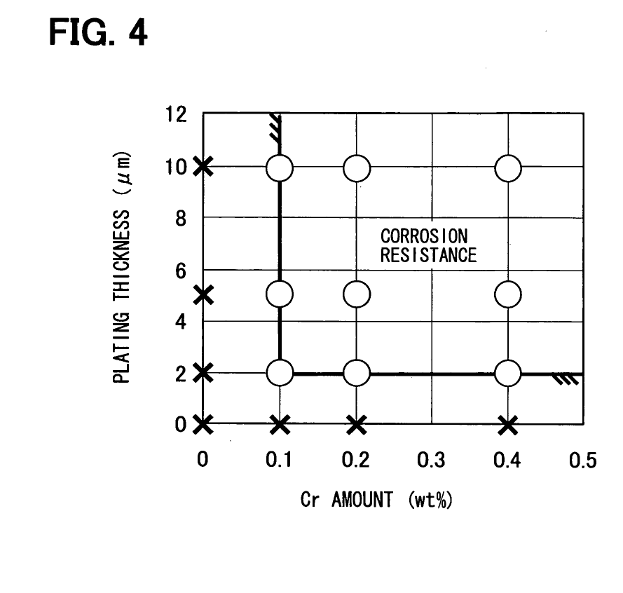

A first embodiment of the present invention will be described with reference to FIGS. 1 to 4. FIG. 1 is a cross sectional view showing an initial state of a metallic material 1 for brazing. FIG. 2 is a cross sectional view showing an intermediate state of brazing the metallic material 1 to another metallic material 2. FIG. 3 is a cross sectional view showing a state after brazing of the metallic material 1 to the another metallic material 2. FIG. 4 is a graph showing the results of experiments of corrosion resistance after the brazing in accordance with initial chrome contents (amounts) of the metallic materials 1 and the plating thicknesses.

As shown in FIG. 1, the metallic material 1 includes a base material portion 10 made of copper or a copper alloy, and a metallic film portion 20 formed on one side of the base material portion 10. The base material portion 10 contains chrome (Cr) 11 by a predetermined amount. The content amount of chrome 11 is 0.1% by weight or more.

The metallic film portion 20 is formed as a thin film layer which is made of metal having a melting point in a temperature range lower than a heating temperature (e.g., 600 to 700° C.) in the brazing to be described later. For example, the metallic film portion 20 is made of any one of tin, a tin alloy, zinc, and a zinc alloy. The melting point of tin is 232° C., and the melting point of zinc is 419.5° C. The metallic film portion 20 is formed into a film shape by any one of electroplating, electroless plating, displacement plating, hot-dip plating, cladding, and thermal spraying. The film thickness of the metallic film portion 20 is 2 μm or more.

Now, a method of brazing the metallic material 1 to another metallic material 2 (hereinafter referred to as the “metallic material 2”) will be described with reference to FIGS. 2 and 3.

### (1) Assembly Step

First, the metallic material 1 and the metallic material 2 each having a predetermined shape (for example, a plate shape) are prepared. The metallic film portion 20 of the metallic material 1 is formed by electroplating of tin. The metallic material 2 (for example, a copper material) previously has a brazing material not shown on its surface. Then, as shown in FIG. 2, both the metallic materials 1 and 2 are assembled in a predetermined positional relationship to form an assembly.

### (2) Brazing Step

Then, the above assembly is introduced into a furnace for brazing. In the brazing, the brazing furnace that is capable of reducing oxidation during the brazing process is used. The brazing furnaces for use include, for example, a vacuum brazing furnace, a reducing atmosphere brazing furnace, an inert atmosphere brazing furnace, and the like.

When the assembly is heated to cause its temperature to rise in the brazing furnace, the metallic film portion 20 (tin) of the metallic material 1 melts to form a molten portion 21 of tin on the outermost surface side thereof, and an alloy portion 22 (copper-tin alloy) by interdiffusion between copper and tin on the base material portion 10 side, respectively. That is, the layer of the alloy portion 22 is formed between the layer of the molten portion 21 and the layer of the base material portion 10 that is not melted.

Chrome 11 of the base material portion 10 is diffused by the molten portion 21 (molten tin) into the surface of the molten portion 21 having a low concentration of chrome from a side of the base material portion 10 having a high concentration of chrome, as indicated by the upward arrow in FIG. 2. Further, while the chrome 11 is diffused as mentioned above, the brazing material of the metallic material 2 is melted to cause the metallic material 1 to be brazed to the metallic material 2.

### (3) Film Formation Step

Next, the assembly is removed from the brazing furnace, and then cooled in the atmosphere. After the brazing, as shown in FIG. 3, the molten portion 21 and the alloy portion 22 as described above by using FIG. 2 forms one new alloy portion 22, and further, the chrome 11 diffused into the surface side of the molten portion is deposited on the surface thereof to form a passive film. That is, the diffused chrome 11 is coupled with oxygen in the atmosphere to form a chrome oxide film 30.

FIG. 4 shows the results of experiments of corrosion resistance on the surface side of the metallic material 1 in a brazed body formed of both the metallic materials 1 and 2 by the above-mentioned brazing method.

Corrosion tests are performed on samples using as reference the content of chrome 11 (% by weight) in the base material portion 10 and the thickness (μm) of an initial plating layer of the metallic film portion 20. The condition of the corrosion test is as follows. The brazed body was immersed into a strong acid solution (pH 2.0). An amount of decrease in weight of each sample due to corrosion after 400 hours was measured to determine the level of corrosion resistance.

In FIG. 4, when the amount of decrease in weight of the sample due to corrosion is larger than 1×10⁻² g/cm², the corrosion property is determined to be poor (×).

In contrast, when the decrease amount in weight of the sample due to corrosion is 1×10⁻² g/cm² or less, the corrosion property is determined to be good (O).

The larger the chrome content amount and the thicker the plating of the metallic film portion 20, the thicker the chrome oxide film 30 formed after brazing. As shown in FIG. 4, when the chrome content amount is equal to 0.1% or more and when the plating thickness of the metallic film portion is 2 μm or more, it was able to be confirmed that good corrosion resistance (O) was obtained.

As mentioned above, according to the brazing method using the metallic material 1 of the present embodiment, in the brazing step, the chrome 11 is in a diffused state to be diffused into the surface, and does not form the chrome oxide film 30. Thus, both the metallic materials 1 and 2 can be brazed well without being inhibited by the chrome oxide film 30. The chrome oxide film 30 is formed in the film formation step after the brazing step, thereby improving the corrosion resistance of the metallic material 1. Accordingly, the present brazing method can be provided as a method giving excellent brazing properties and corrosion resistance.

Because the metallic film portion 20 is made of any one selected from tin, a tin alloy, zinc, and a zinc alloy, the metallic film portion 20 having the low melting point as compared to the brazing heating temperature can be set easily.

Furthermore, because the metallic film portion 20 is formed by any one of the electroplating, the electroless plating, the displacement plating, the hot-dip plating, the cladding and the thermal spraying, the metallic film portion 20 can be formed easily.

A second embodiment of the present invention will be described. In the second embodiment, the metallic material 1 and the brazing method of both the metallic materials 1 and 2 described in the first embodiment are typically used for a heat exchanger.

For example, in the heat exchanger such as a radiator made of copper, a fin (first member) included in a heat exchanging portion is formed of the metallic material 1. A tube (second member) is formed of the metallic material 2. A plurality of tubes and fins are stacked to form the heat exchanging portion in the heat exchanger, which is generally known. The metallic material 1 for forming the fin has the metallic film portions 20 formed on the front and back surfaces of the base material 10. That is, in the second embodiment, the metallic material 1 before brazing has the metallic film portions 20 of two layers on both the front and back surfaces of the base material 10.

The fin is formed by applying a roller working operation to the metallic material 1 which is a thin band plate, thereby to form the metallic material 1 in a wave-like shape. Likewise, the tube is formed by bending the metallic material 2 which is a thin band plate thereby to cause the metallic material 2 to have a flat oblong section. That is, a flat tube is formed by using the metallic material 2. The brazing material is provided on the front surface of the flat tube.

The fins and the tubes are stacked alternately to form the heat exchanging portion, and header tanks made of copper are connected to both ends of the tubes in the tube longitudinal direction, thereby constituting a heat exchanger assembly such as a radiator assembly. These elements are integrally brazed in a brazing furnace in an oxidation reduction atmosphere.

As described in the above first embodiment, in the brazing, the metallic film portion 20 of the fin (tin) is melted to form the molten portion 21 of tin on the front and back surfaces thereof. The chrome 11 of the base material portion 10 is diffused into each of the front and back surfaces by the molten portion 21. Further, while the chrome 11 is diffused as mentioned above, the brazing material of the tubes is melted to braze the fins to the tubes, and also to braze the tubes to the header tanks.

When the radiator assembly is removed from the brazing furnace and cooled in the atmosphere, the chrome 11 diffused into each of the front and back surfaces of the fins is deposited on the surface to form the passive film, that is, the chrome oxide film 30.

In the second embodiment, the metallic materials 1 and 2 are used for the fins and tubes of the heat exchanger. Even in this case, the brazing method of the present invention has excellent brazing properties between the fins and tubes. The fins may be disadvantageous to external corrosion because they are formed of thin band plates. But, after the brazing process, the chrome oxide film 30 is formed on the front and back surfaces of the fin, it can improve the corrosion resistance. Accordingly, it is possible to provide the heat exchanger having excellent corrosion resistance.

In the above-described second embodiment, both the metallic materials 1 and 2 are used for components of the heat exchanger, such as the fin and tube. However, the components of the heat exchanger are not limited to the fin and tube. Furthermore, in the second embodiment, the tube may be formed from the metallic material 1 and the fin may be formed from the metallic material. The metallic materials 1 and 2 are not limited to a combination of the fins and tubes, and may be used for a combination of other members, such as a combination of tubes and header tanks.

The heat exchanger is not limited to the radiator, and may be used for other devices, including a heater core for a heater, an inter cooler for cooling an engine feeding air, or the like.

Although the present invention has been fully described in connection with the preferred embodiments thereof with reference to the accompanying drawings, it is to be noted that various changes and modifications will become apparent to those skilled in the art.

According to an aspect of the present invention, a metallic material for brazing includes a base material portion 10 made of copper or a copper alloy containing chrome 11 in a predetermined amount, and a metallic film portion 20 that is made of a material having a melting point lower than a heating temperature in brazing and is provided on a surface of the base material portion 10.

When the metallic material 1 for brazing is used to be brazed to another metallic material 2 in an oxidation reduction atmosphere, the metallic film portion 20 becomes a molten state. The metallic material 1 is brazed to the another metallic material 2, while the chrome 11 in the base material portion 10 is diffused into a surface of the metallic material by the molten metallic film portion 20. After the brazing, the chrome 11 diffused into the surface of the metallic material forms the chrome oxide film 30 in the atmosphere.

Accordingly, the brazing can be accurately and effectively performed without being inhibited by the chrome oxide film 30 during the brazing. The chrome oxide film 30 after the brazing can improve the corrosion resistance of the metallic material 1 for brazing. As a result, the metallic material 1 for brazing can be provided as a material having excellent brazing properties and corrosion resistance.

The metallic film portion 20 may be made of any one of tin, a tin alloy, zinc, and a zinc alloy. Thus, it is possible to easily set the metallic film portion 20 having a low melting point.

The metallic film portion 20 may be provided by any one of electroplating, electroless plating, displacement plating, hot-dip plating, cladding, and thermal spraying. In this case, it is possible to easily form the metallic film portion 20.

The predetermined amount of the chrome contained may be 0.1% by weight or more. In this case, it is possible to easily form a thick chrome oxide film 30 after the brazing, thereby ensuring a sufficient corrosion resistance.

A thickness of the metallic film portion 20 may be 2 μm or more. In this case, the molten state of the metallic film portion 20 can be surely formed in brazing, thereby inducing the more diffusion of the chrome 11 into the surface thereof. Thus, a relatively thick chrome oxide film 30 can be formed after the brazing.

According to another aspect of the present invention, a brazing method for brazing the metallic material 1 for brazing to another metallic material 2 includes an assembling step for assembling the metallic material 1 for brazing and the another metallic material 2 in a predetermined positional relationship to form an assembly; a brazing step for heating and brazing the assembly in the oxidation reduction atmosphere, in which the metallic film portion 20 is melted to diffuse the chrome 11 into the surface of the metallic material 1 for brazing during the brazing step; and a film formation step for forming a chrome oxide film 30 by using the chrome 11 diffused into the surface of the metallic material 1 for brazing in an atmosphere after the brazing step.

In the brazing step, the chrome 11 is in a diffused state to be diffused into the surface, and does not form the chrome oxide film 30. Therefore, the brazing property can be performed without being inhibited by the chrome oxide film 30. The chrome oxide film 30 formed in the film formation step after the brazing step can improve the corrosion resistance of the metallic material 1 for brazing. Accordingly, the brazing properties and corrosion resistance can be effectively improved.

The metallic material 1 for brazing and the another metallic material 2 may be materials for forming a first member and a second member, respectively, for constituting a heat exchanger. Accordingly, it can provide the brazing method for the heat exchanger having excellent brazing properties. Furthermore, a completed heat exchanger having excellent corrosion resistance can be formed.

For example, the first member may be a fin for external fluid heat transfer of a heat exchanger, and the second member may be a tube for internal fluid circulation of the heat exchanger. In this case, even when each fin is formed of a thin material, the corrosion resistance of each fin can be improved in the heat exchanger.

According to another aspect of the present invention, a heat exchanger includes a first member formed of the metallic material 1 for brazing, and a second member formed of another metallic material 2. Furthermore, the first member and the second member are brazed to each other, and a chrome oxide film 30 is formed on a surface of the first member by using the chrome 11 diffused into the surface in the brazing. Accordingly, it is possible to provide the heat exchanger with the excellent corrosion resistance.

Such changes and modifications are to be understood as being within the scope of the present invention as defined by the appended claims.

What is claimed is:

1. A metallic material for brazing to be used for brazing in an oxidation reduction atmosphere, the metallic material comprising:
a base material portion made of copper or a copper alloy containing chrome in a predetermined amount; and
a metallic film portion made of a material having a melting point lower than a heating temperature in brazing, and provided on a surface of the base material portion.

2. The metallic material for brazing according to claim 1, wherein the metallic film portion is made of any one of tin, a tin alloy, zinc, and a zinc alloy.

3. The metallic material for brazing according to claim 1, wherein the metallic film portion is provided by any one of electroplating, electroless plating, displacement plating, hot-dip plating, cladding, and thermal spraying.

4. The metallic material for brazing according to claim 1, wherein the predetermined amount of the chrome contained in the base material portion is 0.1% by weight or more.

5. The metallic material for brazing according to claim 1, wherein a thickness of the metallic film portion is 2 μm or more.

6. A brazing method for brazing the metallic material for brazing according to claim 1, to another metallic material, the brazing method comprising steps of:
assembling the metallic material for brazing and the another metallic material in a predetermined positional relationship so as to form an assembly;
heating and brazing the assembly in the oxidation reduction atmosphere, in which the metallic film portion is melted to diffuse the chrome into the surface of the metallic material for brazing in the heating and brazing step; and
forming a chrome oxide film by using the chrome diffused into the surface of the metallic material for brazing in an atmosphere, after the brazing step.

7. The brazing method according to claim 6, wherein the metallic material for brazing and the another metallic material are materials for forming a first member and a second member, respectively, for forming a heat exchanger.

8. The brazing method according to claim 7,
wherein the first member is a fin for external fluid heat transfer, and the second member is a tube for internal fluid circulation, and
wherein the fin and the tube are used for forming a heat exchanging portion of the heat exchanger.

9. A heat exchanger comprising:
a first member formed from the metallic material for brazing according to claim 1;
a second member formed from another metallic material, the first member and the second member being brazed to each other in the brazing; and
a chrome oxide film formed on a surface of the first member by diffusion of the chrome into the surface during the brazing.
